(19) United States
(12) Patent Application Publication
(10) Pub. No.: US 2006/0091810 A1
(43) Pub. Date: May 4, 2006

(54) Light-transmitting substrate provided with a light-absorbing coating

(76) Inventors: Abraham Balkenende, Eindhoven (NL); Melanie Wagemans, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/530,496

(22) PCT Filed: Oct. 2, 2003
(86) PCT No.: PCT/IB03/04351

§ 371 Date: Apr. 6, 2005

(30) Foreign Application Priority Data
Oct. 11, 2002 (EP) 02079250.3

(51) Int. Cl. H01J 61/35

(52) U.S. Cl. 313/635

(57) ABSTRACT

Disclosed is a light-transmitting substrate that is at least partly provided with a light-absorbing coating. Said coating comprises silver or gold particles that are incorporated in a sol-gel matrix. In order to improve the transmittance in red and to reduce the amount of silver and gold particles, a blue-absorbing compound is added to the coating. Furthermore, an electric lamp is disclosed, said lamp comprising a light-transmitting lamp vessel that accommodates a light source. Said lamp vessel comprises the above light-transmitting substrate. Moreover, a light-absorbing coating is disclosed.

The present invention relates to a light-transmitting substrate that is at least partly provided with a light-absorbing coating, said coating comprising silver and/or gold particles that are incorporated in a sol-gel matrix. The invention further relates to an electric lamp comprising a light-transmitting lamp vessel that accommodates a light source, wherein said lamp vessel comprises the above light-transmitting substrate. Furthermore the present invention relates to the light-absorbing coating itself.

Light-transmitting substrates provided with a light-absorbing coating can be used as a color layer on or in front of (incandescent) lamps for general lighting purposes. The substrate may comprise, for example, a colored filter made of a—flat or non-flat shaped—piece of glass, which is designated to be placed in a trajectory of light, said light being generated by a lamp. Such an arrangement is often used in outdoor lighting. Another example of a light-transmitting substrate is a lamp vessel that is placed over a light source of an electric lamp. Such electric lamps are predominantly used as indicator lamps in vehicles, for example as red-colored light sources in red tail and brake lights of automobiles. Said electric lamps may also be used in traffic lights.

The main advantage of using specifically metal particles such as silver or gold, over ordinary—organic or inorganic—pigments is the absence of thermochromic behavior. In addition, diffuse scattering is very small due to the extremely small size of the particles.

The color appearance of a coating material containing metal nanoparticles, such as gold and silver, can be tuned as the optical absorption of metal particles is shifted towards longer wavelengths when they are embedded in dielectrics with higher refractive indices. For example, for gold particles the absorption peak is 520 nm (green) or 620 nm (red) when incorporated in a SiO₂-matrix or a TiO₂ matrix, respectively. Choosing the proper metal and matrix material can obtain a specific color.

A coating comprising silver or gold incorporated in a sol-gel matrix is known, for example, from U.S. Pat. No. 5,731,091.

However, an important disadvantage of said coatings is that the gold and silver particles embedded in a suitable matrix material are strongly absorbing in the yellow-green part of the spectrum in particular. This results in coatings that are transmitting in the blue and red parts of the spectrum. In order to reduce the blue transmission sufficiently and to obtain red-transmitting coatings, large amounts of gold and silver particles are needed. It will be clear that this is a cost disadvantage. In addition, a decrease in the blue transmission of the coating also decreases the red absorption, thus decreasing the effective light output of the lamp. With coatings comprising silver, the main drawback is the small transmittance of a red coating, which is less than about 11%.

The present invention aims to provide a light-transmitting substrate according to the preamble, in which the above disadvantages are obviated. Moreover, the present invention aims to provide a coating that does not show the above disadvantages.

To this end, the present invention provides a light-transmitting substrate according to the preamble that is characterized in that a blue-absorbing compound is added to the coating.

By adding a blue-absorbing compound to the coating, such that the light in the blue part of the spectrum is absorbed, a red-transmitting coating is obtained without the need for very high amounts of gold or silver particles. On the contrary, the amounts of gold and silver can be reduced considerably. For example, in the case of gold, the amount can be reduced by a factor of 5. In the case of silver, an additional advantage is that a matrix with a higher refractive index can be used, for example about 2.3, causing the transmittance to rise to 20%.

Such a blue-absorbing compound absorbs the light in the blue part of the spectrum. Thus, in the case of a light-absorbing coating comprising silver and/or gold particles that is strongly absorbing in the yellow-green part of the spectrum, the addition of a blue-absorbing compound results in absorption in both the yellow-green and the blue part of the spectrum. The red part of the spectrum thus remains light-transmitting, without the need for very high amounts of silver or gold particles.

The blue absorbing compound may either be an organic or an inorganic compound. In general any yellow-absorbing pigment can be used as long as the absorption at wavelengths above 590 nm is very low or negligible. The temperature to which the substrate—for example the glass vessel—is subjected also determines the choice between organic and inorganic compounds. In the case of high temperatures inorganic compounds are preferred, while in case of lower temperatures organic compounds may be advantageous.

The blue-absorbing compound may be added to the light-absorbing coating layer. However, in a particular embodiment, the blue-absorbing compound is present in an additional layer.

Such an additional layer is preferably adjacent to the light-absorbing coating layer. The additional layer may be applied on top of the coating or between the coating and the substrate.

However, in another preferred embodiment of the present invention, the blue-absorbing compound is present in the substrate. For example, the blue-absorbing compound may be present in the glass of the lamp vessel.

Preferred examples for the inorganic compounds comprise Fe₂O₃, compounds with the general formula Zn₍₁₋ₓ₎Fe₍₂₊ₓ₎O₄, such as Zn Fe₂O₄, and V₂O₅. However, other inorganic compounds may also provide for good results. For example, Ag may be added to an Au/MTMS coating in order to provide for absorption in blue.

The above-mentioned blue-absorbing compounds or pigments are very well known. For example, Fe₂O₃ is as such also used as the main pigment in a light-absorbing coating for a lamp vessel of an electric lamp. Iron oxide (Fe₂O₃) is an orange pigment and P-doped Fe₂O₃ is an orange-red pigment. In this connection reference is made to WO 01/20641 in the name of the Applicant. An important difference between WO 01/20641 and the present invention is that the inorganic pigment is used as the main pigment for absorbing part of the visible light in WO 01/20641, whereas in the present invention gold and silver are the main light-absorbing constituents. In the present invention, the inorganic pigment is specifically added to absorb the light in the blue region, thereby allowing for lesser amounts of gold and silver.

The present invention also relates to an electric lamp comprising a light-transmitting lamp vessel which accommodates a light source, said lamp vessel comprising a light-transmitting substrate according to the above.

As mentioned in the above, said electric lamps can advantageously be used as indicator lamps in vehicles, for example as red-colored light sources in red tail and brake lights of automobiles.

Moreover, the present invention relates to a light-absorbing coating according to the above.

These and other aspects of the invention will be apparent from and elucidated with reference to the embodiments described hereinafter.

In the drawings:

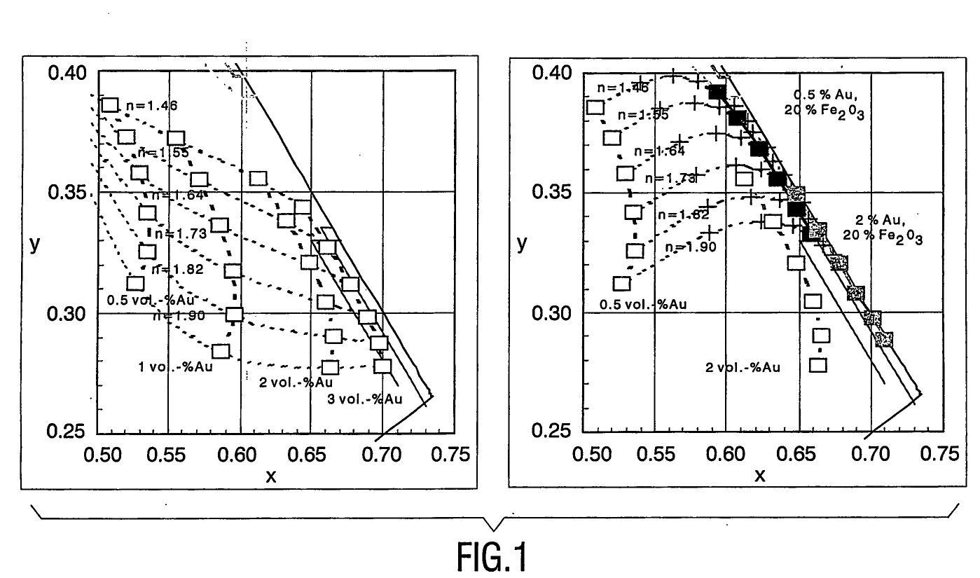

FIG. 1 shows, in a part of a C.I.E. chromaticity diagram, the color co-ordinates of a light-transmitting substrate provided with a light-absorbing coating containing gold particles;

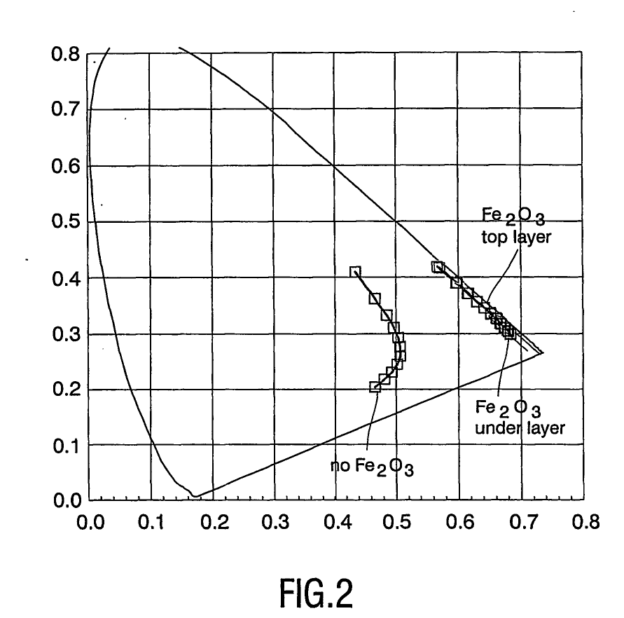

FIG. 2 shows, in a part of a C.I.E. chromaticity diagram, the color co-ordinates of a light-transmitting substrate provided with a light-absorbing coating containing silver particles.

The present invention will be elucidated by means of the following manufacturing examples of the preparation of a coating and the application of said coating to a substrate.

### EXAMPLE 1

### Gold in MTMS/TEOS

A sol-gel hydrolysis mixture is made by mixing 4.3 g ethanol, 40.0 g methyltrimethoxy silane (MTMS), 0.86 g tetraethoxy silane (TEOS), and 0.14 g 0.1 M acetic acid in 32.0 g water and subjecting said mixture to hydrolysis during 48 hours.

A Fe₂O₃ dispersion is made by mixing 3 g Fe₂O₃, 3 g Dysperbyk-190, 7 g water, and 10 g ethanol. This dispersion is added to the sol-gel hydrolysis mixture and methoxypropanol in a 1:2:0.2 ratio. Spin coating of the resulting solution on a glass plate or spraying onto a rotating glass envelope results in a 2 μm thick coating containing about 20 vol.-% Fe₂O₃.

Subsequently, 1 g of a Au particle dispersion comprising 25 wt % gold particles, 7 wt % polymer, and 68 wt % ethanol is mixed with a sol-gel hydrolysis mixture similar to the one described above in a 1-to-2 ratio. The polymer that is used to stabilize the metal particles is a polystyrene-polycarbonate block copolymer.

The coating liquid is subsequently spin coated onto the outer surface of a glass substrate covered with the Fe₂O₃-containing coating. The coating is cured for 30 minutes at a temperature of 350° C., resulting in a red coating. The layer thickness is about 2.8 μm.

A similar result can be obtained when the Au-dispersion is directly added to the mixture containing the sol-gel hydrolysis mixture and the Fe₂O₃-containing dispersion. The layer is applied in a single step in this case.

### EXAMPLE 2

### Silver in TEOTi

First a 2 μm thick silica layer containing about 20 vol. % Fe₂O₃ is applied as in example 1.

A sol-gel hydrolysis mixture is made by mixing 20 g ethanol, 3.3 g tetraethoxy titane (TEOTi), and 2.35 g 0.1 M HCl and subjecting said mixture to hydrolysis during 48 hours.

Subsequently, a 1 g of a Ag particle dispersion comprising 17 wt % silver particles, 13 wt % polymer and 70 wt % ethanol, is added to 2 g of ethanol and 2.5 g of 10 wt % N-aminopropyltrimethoxysilane in ethanol. This solution is mixed with the TEOTi solution in a ratio of 1-to-2. The polymer that is used to stabilize the metal particles is a polystyrene-polycarbonate block copolymer.

The coating liquid is prepared by mixing the silver solution and the sol-gel hydrolysis mixture. The coating liquid is subsequently spin-coated onto a glass substrate covered with a Fe₂O₃-containing coating and cured at a temperature of 350° C. in air. The layer thickness of the coating is 200 nm.

FIG. 1 shows, in a part of a C.I.E. chromaticity diagram, the color co-ordinates of a light-transmitting substrate provided with a light-absorbing coating comprising Au particles as obtained from simulations. The red color is specified by x=0.665 and y=0.335.

In the left side of FIG. 1, the color point is shown of a 2 μm thick coating of gold particles incorporated in a matrix. The refractive index varies from 1.46 to 1.90, and the Au content varies from 0.5 to 3 vol. %. Only at the 3 vol. % Au content does the transmitted color fall within the red specification. The highest transmission is then obtained with a refractive index of about 1.5. The layers containing a smaller amount of Au fail to produce a red color because their transmission in the blue region is too large.

The right hand side of FIG. 1 shows how the addition of Fe₂O₃ to the light-absorbing coating improves the red color transmission. By using the coating according to the present invention—e.g. the coating according W example 1: a Au/sol-gel coating to which about 20 vol. % Fe₂O₃ is added—the blue transmission is effectively blocked. In this way a layer with a refractive index of 1.90 containing only 0.5 vol. % Au comes within the red specification. If the refractive index of the layer is low (n=71.5), the amount of Au can be lowered to about 2 vol. %.

FIG. 2 shows, in a part of a C.I.E. chromaticity diagram, the color co-ordinates of a light-transmitting substrate provided with a light-absorbing coating containing silver particles as obtained from simulations.

It is clearly shown that the coating not containing any Fe₂O₃ or having any Fe₂O₃ layer adjacent to it fails to produce a red color according to the specification.

However, the addition of a 2 μm thick silica layer containing about 20 vol. % Fe₂O₃ to the Ag containing coating layer—e.g. according to example 2—shifts the color point toward the red region. As shown in FIG. 2, the color point and transmission are not strongly dependent on the position of the Fe₂O₃ layer.

It will be clear that, within the scope of the invention, many variations are possible to those skilled in the art. Many alternative preparation methods, both wet-chemical and physical deposition methods, are possible. Furthermore, it is also possible to use other blue-absorbing compound combinations to cause the desired color point shift.

The scope of protection of the invention is not limited to the examples given herein. The invention is embodied in each novel characteristic and each combination of characteristics.

1. A light-transmitting substrate which is at least partly provided with a light-absorbing coating, said coating comprising silver and/or gold particles that are incorporated in a sol-gel matrix, a blue-absorbing compound being added to the coating.

2. A light-transmitting substrate according to claim 1, characterized in that the blue-absorbing compound is present in an additional layer.

3. A light-transmitting substrate according to claim 1, characterized in that the blue-absorbing compound is present in the substrate.

4. A light-transmitting substrate according to claim 1, characterized in that the blue-absorbing compound comprises an inorganic compound.

5. A light-transmitting substrate according to claim 4, characterized in that the inorganic compound comprises Fe₂O₃, compounds with the general formula Zn₍₁₋ₓ₎Fe₍₂₊ₓ₎O₄, such as Zn Fe₂O₄, or V₂O₅.

6. An electric lamp comprising a light-transmitting lamp vessel that accommodates a light source, said lamp vessel comprising a light-transmitting substrate according to claim 1.

7. Light-absorbing coating according to claim 1.
